(19) United States
(12) Patent Application Publication
(10) Pub. No.: US 2006/0072842 A1
(43) Pub. Date: Apr. 6, 2006

(54) Image segmentation based on block averaging

(75) Inventors: Stephen Herman, Monsey, NY (US); Erwin Bellers, Fremont, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/545,842

(22) PCT Filed: Dec. 5, 2003
(86) PCT No.: PCT/IB03/05794

§ 371 Date: Aug. 17, 2005

Related U.S. Application Data
(60) Provisional application No. 60/433,310, filed on Dec. 13, 2002.

(51) Int. Cl. G06K 9/40

(52) U.S. Cl. 382/254

(57) ABSTRACT

A method and system for improving the quality of a video image (100) segmented into a plurality of blocks (110, 115, 120) of known size is disclosed. The method comprises the steps of associating a value to each of said blocks and altering said associated value corresponding to a selected one of said blocks when each of said associated values of blocks adjacent to said selected block is different than said selected block associated value. The block value is a first value when said block probability function is greater than a threshold value, otherwise it a set as a second value.

### BACKGROUND OF THE INVENTION

This invention relates to video processing and more specifically to classifying and segmenting regions of pixels base upon characteristics such as color and texture.

### SUMMARY OF THE INVENTION

A method and system for improving the quality of a video image segmented into a plurality of blocks of known size is disclosed. The method comprises the steps of associating a value to each of said blocks and altering said associated value corresponding to a selected one of said blocks when each of said associated values of blocks adjacent to said selected block is different than said selected block associated value.

### BRIEF DESCRIPTION OF THE DRAWINGS

In the drawings:

FIG. 1 illustrates a segment of an image organized in 8×8 pixel blocks;

FIG. 2 illustrates a flow chart an exemplary process for an improved segmentation method in accordance with the principles of the invention;

FIG. 3 illustrates a flow chart an exemplary second process for an improved segmentation method in accordance with the principles of the invention;

FIG. 4 illustrates a system for executing the processing shown in FIGS. 2 and 3.

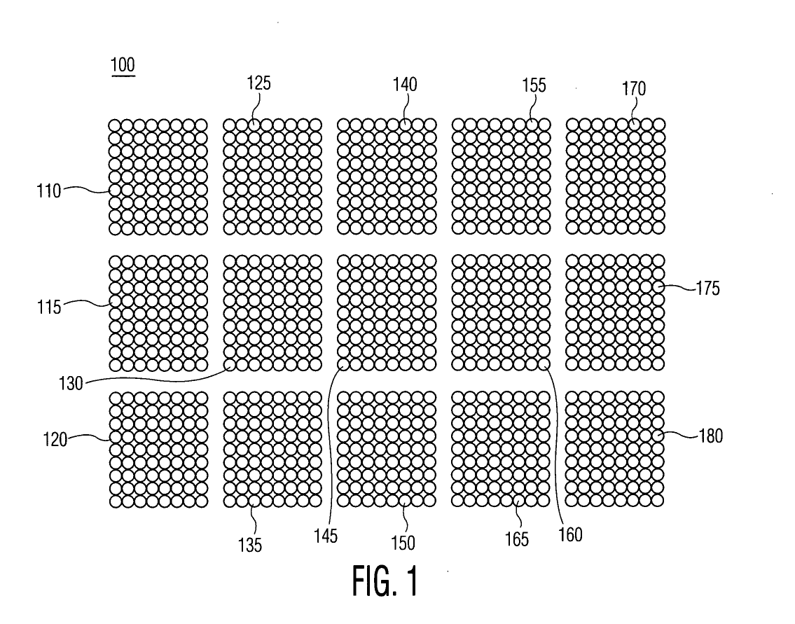

It is to be understood that these drawings are solely for purposes of illustrating the concepts of the invention and are not intended as a definition of the limits of the invention. The embodiments shown in FIGS. 1 through 4 and described in the accompanying detailed description are to be used as illustrative embodiments and should not be construed as the only manner of practicing the invention. The same reference numerals, possibly supplemented with reference characters where appropriate, have been used to identify similar elements.

### DESCRIPTION OF THE INVENTION

Segmentation of video images, such as television images, is the process wherein each frame of a sequence of images is subdivided into regions or segments. Each segment includes a cluster of pixels that encompass a region of the image with common properties or characteristics. For example, a segment may be distinguished by a common color, texture, shape, amplitude range or temporal variation. Several methods are known for image segmentation using a process wherein a binary decision determines how the pixels will be segmented. According to such a process, all pixels in a region either satisfy a common criteria for a segment and are therefore included in the segment, or they do not satisfy the criteria and are completely excluded: While these segmentation methods are satisfactory for some purposes, they are unacceptable for many others. In the case of moving image sequences, small changes in appearance, lighting or perspective may only cause small changes in the overall appearance of the image. However, application of a segmentation method such as that described above tends to allow regions of the image that should appear to be the same to satisfy the segmentation criteria in one frame, while failing to satisfy it in another. One of the main reasons for segmenting images is to conduct enhancement operations on the segmented portions. When the image is segmented according to a binary segmentation method such as that previously described, the subsequently applied enhancement operations often produce random variations in image enhancement, usually at the edges of the segmentation regions. Such random variations in moving sequences represent disturbing artifacts that are unacceptable to viewers. Image enhancement in the television setting includes both global and local methods. While local enhancement methods are known, they are currently controlled by global parameters. For example, an edge enhancement algorithm may adapt to the local edge characteristics, but the parameters that govern the algorithm (i.e., filter frequency characteristics) are global—the enhancement operations that are applied are the same for all regions of the image. The use of global parameters limits the most effective enhancement that can be applied to any given image. Improved enhancement would be available if the algorithm could be trained to recognize the features depicted in different segments of the image and could therefore allow the image enhancement algorithms and parameters that are optimum for each type of image feature to be chosen dynamically.

However, one of the principle problems with the current state of the art is that it is essentially pixel-based. As the characteristics such as color and luminance within a segment may vary significantly from pixel to pixel, the determined segment probability function may include significant “noise-like” indicators. When the input video signal also includes noise, the resultant segment probability function becomes even more noise-like. One method of reducing the noise-like indicators in the probability distribution is to process it using a low-pass filter. However, such processing has the undesirable side-effect of removing the texture in the segment of the image.

Hence, there a need for a method and system for reducing the effects of the noise in the determined segment probability function, while maintaining the image texture.

### DETAILED DESCRIPTION OF THE INVENTION

As is known, video images may have significant areas or segments that may be identified as having substantially the same characteristics, e.g., color, luminosity, texture. For example, a segment of an image may contain information related to a sky, i.e., blue color, smooth texture. Similarly, fields of grass may be identified by its green color and semi-smooth texture. Such identification of areas, or segments of video images are more fully discussed in commonly assigned, co-pending related patent application Ser. No. ______ and commonly assigned, co-pending related patent application Ser. No. ______, which disclose determining a probability function for each such segment identified.

FIG. 1 illustrates a pixel element view 100 of a portion of an image segment that is identified as having similar color, texture or luminosity. It will be understood that the principles of the present invention are applicable to each segmented determined in a video image frame. In this exemplary illustration, pixel elements within an arbitrarily selected segment are organized into blocks of 8×8 pixel elements. It will be appreciated that while the present invention is discussed with regard to 8×8 pixel element blocks, the block size may be of any size or number of pixel elements, such as 7×7, 9×9, 16×16, etc. Conventionally, the block size is selected using a power of 2, i.e., 8×8, 16×16, 32×32, etc., as this allows transformation from one block size to another through simple binary shifts, i.e., dividing by powers of 2.

Furthermore, it would be understood that the block size need not be symmetrical as shown, but may contain any number of pixel elements in either length or width. Only for the purposes of clearly illustrating and discussing the present invention, are the image pixel elements of the selected segment grouped into 8×8 blocks, represented as blocks 110-180.

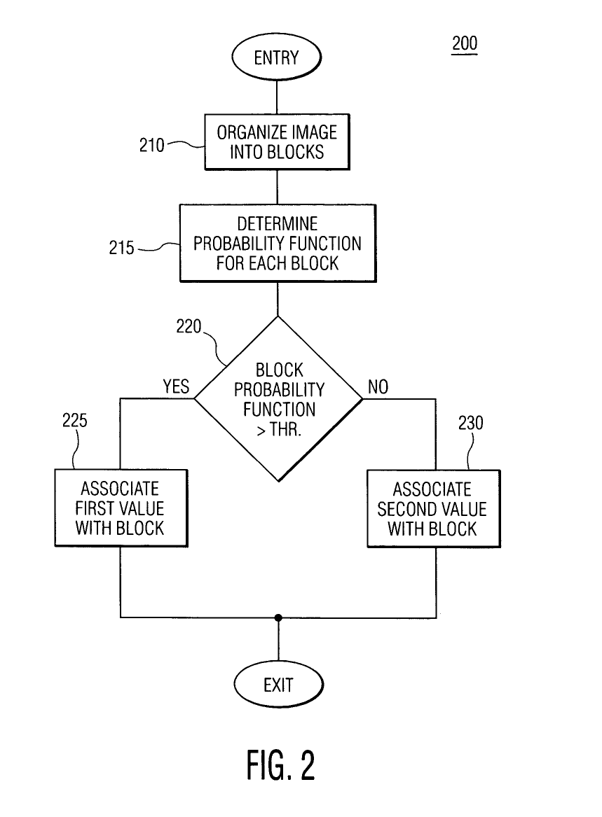

FIG. 2 illustrates a flow chart of an exemplary processing 200 in accordance with the principles of the invention. In this exemplary process 200, pixel elements are organized into blocks, such as those shown in FIG. 1, at block 210. At block 215, a probability function calculated for each pixel within a block is averaged or weighted using known averaging or weighting functions. At block 220, the average or weighted value of the probability function associated with each block is then compared to a threshold value. When the average value of the probability function of a block is greater than the threshold, a first new value is associated with the pixel block at block 225. However, when the average value of a block is less than the threshold value then a second new value is associated with the pixel block at block 230. For example, a logical one may be associated with a block when its average or weighted probability function value is greater than a threshold value and a logical zero may be associated with a block when its average or weighted probability function value is less than a threshold value. Similarly, the first new value may be selected as a logical “0” and the corresponding second new value may be selected as a logical “1”. In a preferred aspect of the invention, a threshold value may be established as a function of the video signal-to-noise ratio (SNR) within the block. Table 1 tabulates exemplary threshold and SNR values on a scale of 0 to 255, wherein 255 is a maximum value.

TABLE 1

| SNR | Threshold Value |
|---|---|
| 20 dB | 67 |
| 26 dB | 112 |
| 32 dB | 130 |

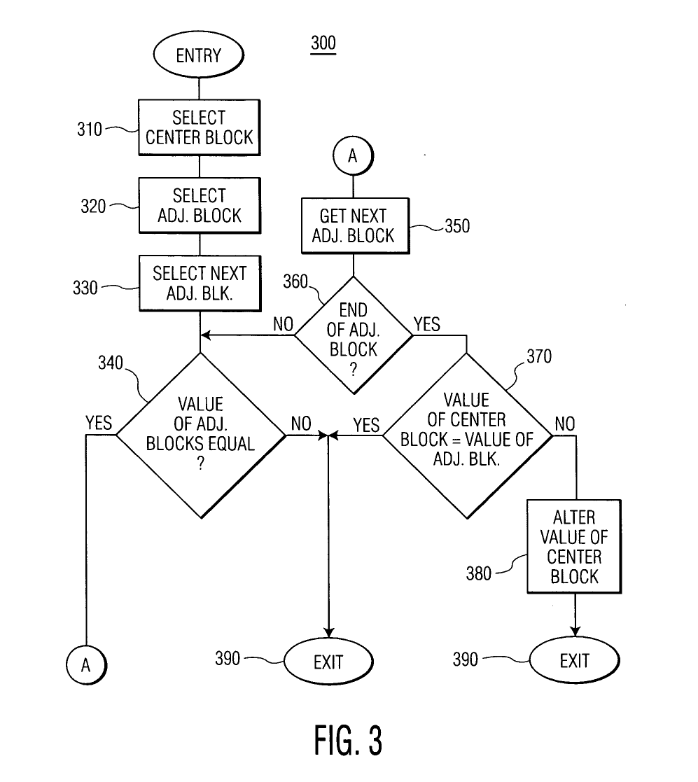

FIG. 3 illustrates a flow chart an exemplary process 300 for improving image segmentation in accordance with the principles of the invention. In this exemplary process, a pixel block is selected at block 310. At block 320, an adjacent pixel block is selected at block 320. At block 330, a next/subsequent pixel block is selected at block 330. At block 340 a determination is made whether the value associated with the selected adjacent pixel blocks are substantially the same. If the answer is negative, then processing on the selected pixel block is completed. However, if the answer is in the affirmative, then a next/subsequent adjacent pixel block is selected at block 350. At block 360, a determination is made whether each of the pixel blocks adjacent to the block selected at block 310 have been processed. If the answer is negative, then a determination is made whether the value of the selected next/subsequent block is substantially the same as a previously selected adjacent block at block 340. Processing continues as previously described.

However, if the answer at block 360 is in the affirmative, then a determination is made at block 370 whether the value of the block selected at block 310 is substantially similar to the value of the adjacent block selected at block 320. If the answer is in the affirmative, then processing on the block selected at block 310 is completed. However, if the answer is negative, then the value of the block selected at block 310 is altered to correspond to the value of the adjacent block selected at block 320. Accordingly, the anomaly value associated with the selected is removed and made comparable to the values of the adjacent blocks.

For example, a block associated with a logical zero value may have all of its associated adjacent pixel blocks having an opposite value of logical one. In this, case, the block associated with the anomalous logical zero value is “removed” by setting its associated value to a logical one value, similar to all the adjacent block associated value. Similarly, if a block with an isolated logical one value is surrounded by blocks associated with a logical zero value, the anomalous logical one value is removed by setting the value to a logic zero.

Returning to FIG. 1, for example, the value associated with block 130 may be altered when the value associated with each of blocks 110, 115, 120, 135, 125, 140, 145, and 150 are substantially the same and different than the value associated with block 130.

In one aspect of the invention, the value associated with each block may then be used to control the processing that is to be done for each pixel within the block. For example, one form of pixel-level processing that may be performed is determine whether a noise filter must be turned on during the processing of each pixel in the block. This method is advantageous to strike a balance between reduced image noise and maintaining appropriate textual information. In another aspect, the values associated with each block may be used to control forms of processing such as modifying the edge sharpness or color of a region differently than other regions.

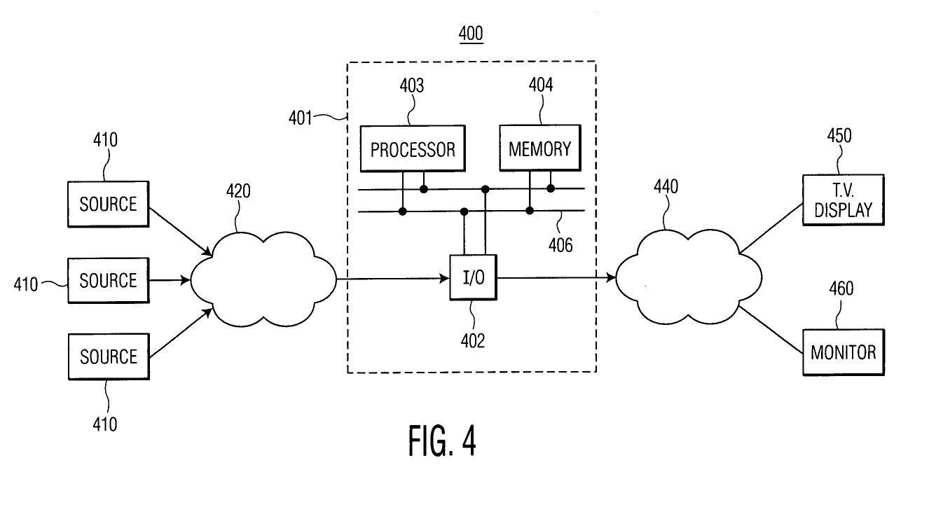

FIG. 4 illustrates an exemplary embodiment of a system 400 that may be used for implementing the principles of the present invention. System 400 may represent a television transmitting or receiving system, desktop, laptop or palmtop computer, a personal digital assistant (PDA), a video/image storage apparatus such as a video cassette recorder (VCR), a digital video recorder (DVR), a TiVO apparatus, etc., as well as portions or combinations of these and other devices. System 400 may contain one or mores sources 410 which are in communication with processor system 401 via one or more networks 420. Processor system 401 is then further in communication with one or more TV displays 450 or Monitors 460 via network 440. Processor system 401 may contain one or more input/output devices 402, processors 403 and memories 404, which may access one or more sources 410 that contain video images. Sources 410 may be stored in permanent or semi-permanent media such as a television transmitter or receiver, a VCR, RAM, ROM, hard disk drive, optical disk drive or other video image storage devices, real time display containing analog or digital images. Sources 410 may alternatively be accessed over one or more network 420 connections for receiving video from a server or servers over, for example a global computer communications network such as the Internet, a wide area network, a metropolitan area network, a local area network, a terrestrial broadcast system, a cable network, a satellite network, a wireless network, or a telephone network, as well as portions or combinations of these and other types of networks.

Input/output devices 402, processors 403 and memories 404 may communicate over a communication medium 406. Communication medium 406 may represent, for example, a bus, a communication network, one or more internal connections of a circuit, circuit card or other apparatus, as well as portions and combinations of these and other communication media. Input data from the sources 410 is processed in accordance with one or more software programs that may be stored in memories 404 and executed by processors 403. Processors 403 may be any means, such as general purpose or special purpose computing system, or may be a hardware configuration, such as a laptop computer, desktop computer, handheld computer, dedicated logic circuit, integrated circuit, Programmable Array Logic (PAL), Application Specific Integrated Circuit (ASIC), etc., that provides a known output in response to known inputs.

In one embodiment, the coding and decoding employing the principles of the present invention may be implemented by computer readable code executed by processor 403. The code may be stored in the memory 404 or read/downloaded from a memory medium such as a CD-ROM or floppy disk (not shown). In another and preferred embodiment, hardware circuitry may be used in place of, or in combination with, software instructions to implement the invention. For example, the elements illustrated herein may also be implemented as discrete hardware elements or as programmable devices operable to execute coed.

After processing the input data, processor 403 may cause the processed data to be transmitted to television display 480 or monitor 490 via network 470. As will be appreciated, networks 420 and 440 may be an internal network among the components, e.g., ISA bus, microchannel bus, PCMCIA bus, etc., or an external network, such as a Local Area Network, Wide Area Network, POTS network, or the Internet.

In one aspect of the invention, the term computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

1. A method for improving the quality of a video image (100) into a plurality of blocks (110, 115, 120) comprising the steps of:
associating a value to each of said blocks; and
altering said associated value corresponding to a selected one of said blocks when each of said associated values of blocks adjacent to said selected block is different than said selected block associated value.

2. The method as recited in claim 1, wherein said block associated value is a first value (225) when said block probability distribution is greater than a selected threshold, otherwise said block value is a second value (230).

3. The method as recited in claim 2, wherein said block probability distribution (215) is representative of an average of a probability distribution associated with each pixel in said block.

4. The method as recited in claim 2 wherein said threshold is selected as a percentage of said block probability distribution.

5. The method as recited in claim 2 wherein said threshold in relation to a signal-to-noise ratio in said block.

6. A system for improving the quality of a video image (100) segmented into a plurality of blocks (110, 115, 120) of known size comprising:
means for associating a value to each of said blocks; and
means for altering said associated value corresponding to a selected one of said blocks when each of said associated values of blocks adjacent to said selected block is different than said selected block associated value.

7. The system as recited in claim 6, wherein said block associated value is a first value (225) when said block probability distribution is greater than a selected threshold, otherwise said value is a second value (230).

8. The system as recited in claim 7, wherein said block probability distribution is representative of an average of a probability distribution associated with each pixel in said block.

9. The system as recited in claim 7, wherein said threshold is selected as a percentage of said block probability distribution.

10. The system as recited in claim 9, wherein said threshold is selected in relation to a signal-to-noise ratio within said block.
